(19) United States
(12) Patent Application Publication
(10) Pub. No.: US 2024/0385943 A1
(43) Pub. Date: Nov. 21, 2024

(54) MODEL ANALYSIS DEVICE, MODEL ANALYSIS METHOD, AND RECORDING MEDIUM

(71) Applicant: NEC Corporation, Minato-ku, Tokyo (JP)

(72) Inventors: Jun NISHIOKA, Tokyo (JP); Yoshiaki Sakae, Tokyo (JP)

(73) Assignee: NEC Corporation, Minato-ku, Tokyo (JP)

(21) Appl. No.: 18/694,032

(22) PCT Filed: Oct. 29, 2021
(86) PCT No.: PCT/JP2021/039981

§ 371 Date: Mar. 21, 2024

(51) Int. Cl. G06F 11/36; G06F 9/445

(52) U.S. Cl. CPC G06F 11/3608; G06F 9/44505

(57) ABSTRACT

A model analysis device according to the present disclosure is provided with: a target information acquisition means that acquires equipment configuration information including hardware configuration information and software configuration information, which consists of firmware configuration information and protocol processing software configuration information, about a verification target; a model information acquisition means that acquires configuration information from which a trained model used to verify the verification target has been generated; a suitability evaluation means that evaluates the suitability of the verification target for the trained model on the basis of the acquired configuration information about the verification target and the trained model; and an output means that outputs the evaluation result.

### TECHNICAL FIELD

The present disclosure relates to a model analysis device, a model analysis method, and a recording medium.

### BACKGROUND ART

For security verification of a specific network device, there is a demand for using a learned model provided by a third party or a learned model generated in the past in the latest environment. When an operation is verified using these learned models, the environment of the own device is required to be similar to the environment in which the learned model is generated.

For example, PTL 1 discloses a server device or the like capable of selecting and supplying an optimum learned model to various devices under different environments, conditions, and the like.

### CITATION LIST

### Patent Literature

PTL 1: JP 2020-161167 A

### SUMMARY OF INVENTION

### Technical Problem

However, the invention described in PTL 1 described above merely selects a model that is compatible between different devices based on data used to generate a learned model. In the verification of the operation of the network device, it is necessary to select a model in consideration of software information configuring the device. However, there are various combinations of software used for the device, and it takes time and effort to select a suitable model.

An example of an object of the present disclosure is to provide a model analysis device capable of easily searching for a compatible learned model in verification of an operation of a network device.

### Solution to Problem

According to an aspect of the present disclosure, a model analysis device includes target information acquisition means that acquires configuration information of a device including hardware configuration information in a verification target and software configuration information formed by firmware configuration information and protocol processing software configuration information, model information acquisition means that acquires configuration information of the device in an environment in which a learned model used for verification of the verification target is generated, suitability evaluation means that evaluates suitability of the verification target with the learned model based on the acquired configuration information of the device of the verification target and the learned model, and output means that outputs the evaluated result.

According to another aspect of the present disclosure, a model analysis device includes target information acquisition means that acquires configuration information of a device including hardware configuration information in a verification target and software configuration information formed by firmware configuration information and protocol processing software configuration information, model search means that searches for a learned model suitable for verification of the verification target based on the acquired configuration information of the device, and output means that outputs the searched learned model.

According to still another aspect of the present disclosure, a model analysis method includes acquiring configuration information of a device including hardware configuration information in a verification target and software configuration information formed by firmware configuration information and protocol processing software configuration information, acquiring configuration information of the device in an environment in which a learned model used for verification of the verification target is generated, evaluating suitability of the verification target with the learned model based on the acquired configuration information of the device of the verification target and the learned model, and outputting the evaluated result.

According to still another aspect of the present disclosure, another model analysis method includes acquiring configuration information of a device including hardware configuration information in a verification target and software configuration information formed by firmware configuration information and protocol processing software configuration information, searching for a learned model suitable for verification of the verification target based on the acquired configuration information of the device, and outputting the searched learned model.

According to still another aspect of the present disclosure, a recording medium stores a program causing a computer to execute acquiring configuration information of a device including hardware configuration information in a verification target and software configuration information formed by firmware configuration information and protocol processing software configuration information, acquiring configuration information of the device in an environment in which a learned model used for verification of the verification target is generated, evaluating suitability of the verification target with the learned model based on the acquired configuration information of the device of the verification target and the learned model, and outputting the evaluated result.

According to still another aspect of the present disclosure, another recording medium stores a program causing a computer to execute acquiring configuration information of a device including hardware configuration information in a verification target and software configuration information formed by firmware configuration information and protocol processing software configuration information, searching for a learned model suitable for verification of the verification target based on the acquired configuration information of the device, and outputting the searched learned model.

### Advantageous Effects of Invention

As an example of an advantageous effect of the present disclosure, it is possible to provide a model analysis device capable of easily searching for a compatible learned model in verification of an operation of a network device.

### BRIEF DESCRIPTION OF DRAWINGS

FIG. 1 a block diagram illustrating a configuration of a model analysis device according to a first embodiment.

FIG. 2 is a diagram illustrating a hardware configuration in which the model analysis device according to the first embodiment is achieved by a computer device and a peripheral device.

FIG. 3 is a table illustrating a storage example of configuration information of a device according to the first embodiment.

FIG. 4 is a flowchart illustrating a model analysis operation according to the first embodiment.

FIG. 5 is a block diagram illustrating a configuration of a model analysis device according to a modified example of the first embodiment.

FIG. 6 is a block diagram illustrating a configuration of a model analysis device according to a second embodiment.

FIG. 7 illustrates an example of a display screen of an adaptive model search tool according to the second embodiment.

FIG. 8 illustrates another example of the display screen of the adaptive model search tool according to the second embodiment.

FIG. 9 is a flowchart illustrating a model analysis operation according to the second embodiment.

### EXAMPLE EMBODIMENT

Next, an embodiment will be described in detail with reference to the drawings.

### First Embodiment

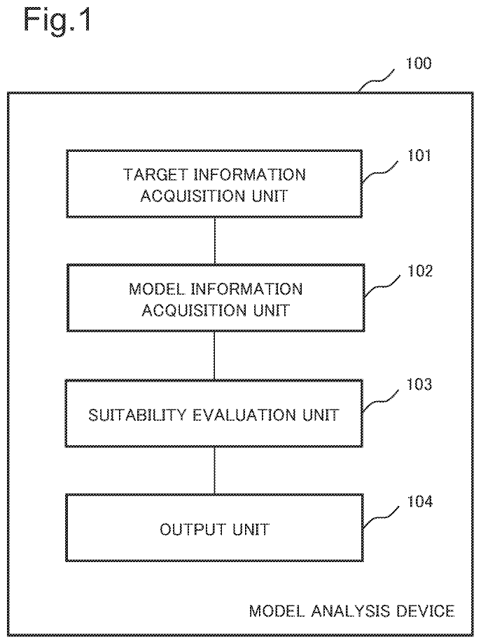

FIG. 1 is a block diagram illustrating a configuration of a model analysis device 100 according to a first embodiment. The model analysis device 100 according to the first embodiment is a device that verifies whether a learned model generated in the own environment in the past or a learned model generated in an environment of other business operators is suitable in a configuration of an own network device when a learned model is shared between a plurality of business operators is suitable. Referring to FIG. 1, the model analysis device 100 includes a target information acquisition unit 101, a model information acquisition unit 102, a suitability evaluation unit 103, and an output unit 104. Hereinafter, the model analysis device 100 that is an essential configuration of the present embodiment will be described in detail.

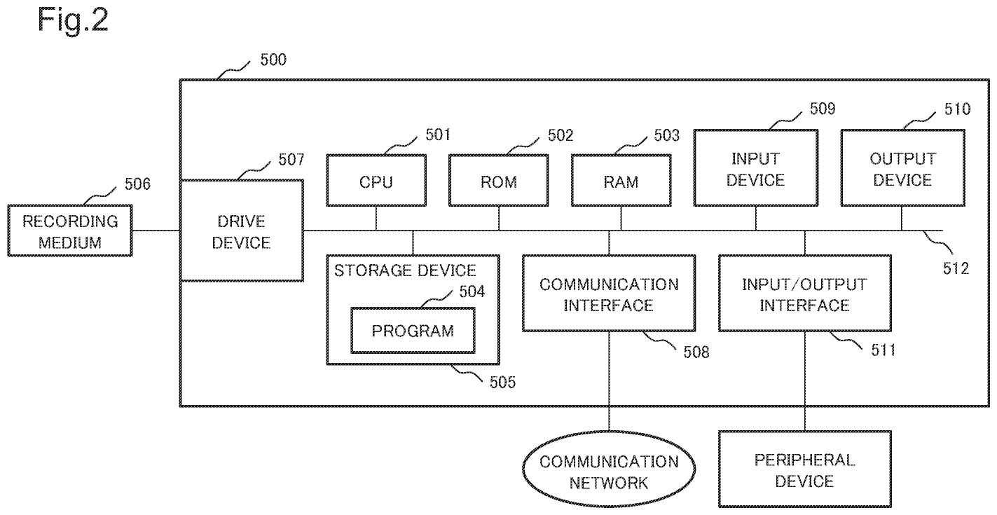

FIG. 2 is a diagram illustrating an example of a hardware configuration in which the model analysis device 100 according to the first embodiment of the present disclosure is achieved by a computer device 500 including a processor. As illustrated in FIG. 2, the model analysis device 100 includes a central processing unit (CPU) 501, a memory such as a read only memory (ROM) 502, and a random access memory (RAM) 503, a storage device 505 such as a hard disk that stores a program 504, a communication interface (I/F) 508 for network connection, and an input/output interface 511 that inputs and outputs data. In the first embodiment, configuration information acquired by the target information acquisition unit 101 and the model information acquisition unit 102 is input to the model analysis device 100 via the input/output interface 511, for example.

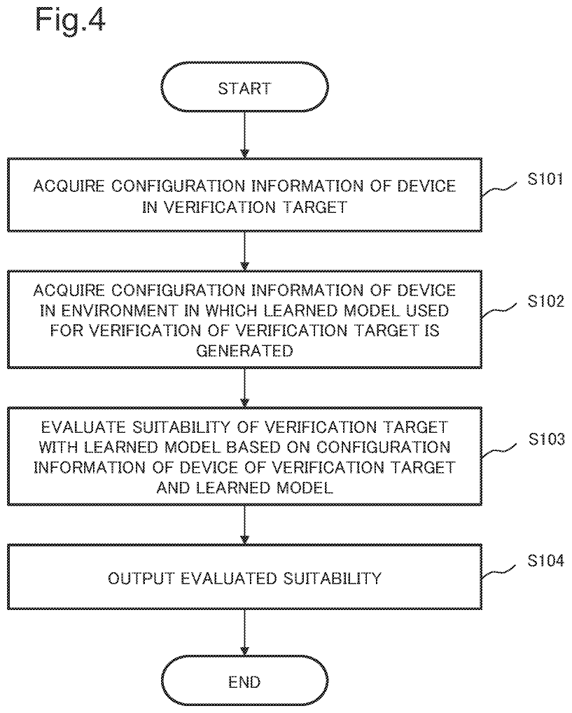

The CPU 501 controls the entire model analysis device 100 according to the first embodiment of the present invention by operating the operating system. The CPU 501 reads a program and data from a recording medium 506 mounted on, for example, the drive device 507 to a memory. The CPU 501 functions as the target information acquisition unit 101, the model information acquisition unit 102, the suitability evaluation unit 103, the output unit 104, and a part thereof in the first embodiment, and executes a process or a command in the flowchart illustrated in FIG. 4 to be described below based on the program.

The recording medium 506 is, for example, an optical disc, a flexible disk, a magnetic optical disk, an external hard disk, a semiconductor memory, or the like. A part of the recording medium of the storage device is a nonvolatile storage device and records a program therein. The program may be downloaded from an external computer (not illustrated) connected to a communication network.

The input device 509 is achieved by, for example, a mouse, a keyboard, a built-in key button, or the like and is used for an input operation. The input device 509 is not limited to a mouse, a keyboard, or a built-in key button and may be, for example, a touch panel. The output device 510 is achieved by, for example, a display and is used to confirm an output.

As described above, the first embodiment illustrated in FIG. 1 is achieved by the computer hardware illustrated in FIG. 2. However, means for achieving each unit included in the model analysis device 100 in FIG. 1 is not limited to the above-described configuration. The model analysis device 100 may be achieved by one physically coupled device or may be achieved by a plurality of physically separated devices connected in a wired or wireless manner. For example, the input device 509 and the output device 510 may be connected to the computer device 500 via a network. The model analysis device 100 according to the first embodiment illustrated in FIG. 1 may be configured with cloud computing or the like.

In FIG. 1, the target information acquisition unit 101 is a unit that acquires configuration information of a device including hardware configuration information in a verification target and software configuration information formed by firmware configuration information and protocol processing software configuration information. The verification in the present embodiment is to verify whether to include an abnormality such as in an operation or security of hardware or software (firmware and protocol processing software) of the network device. The verification target also includes a configuration including a plurality of network devices.

The hardware configuration is, for example, chip configuration information for controlling an operation of a device. The chip configuration information includes a chip architecture, a manufacturer name, and a model number. The firmware information is information regarding software for operating hardware and includes, for example, a firmware name and a version number. The protocol information includes information regarding a protocol name and protocol processing software (routing software). The protocol name is, for example, a protocol name of Layer 3 that is a “network layer” in the third layer of the Open Systems Interconnection (OSI) reference model. Specific examples of the protocol name include Border Gateway Protocol (BGP), Open Shortest Path First (OSPF), and Spanning Tree Protocol (STP). The protocol processing software includes, for example, “GoBGP” or “FRR” when the protocol is BGP, and “FRR” or “Quagga” when the protocol is OSPF.

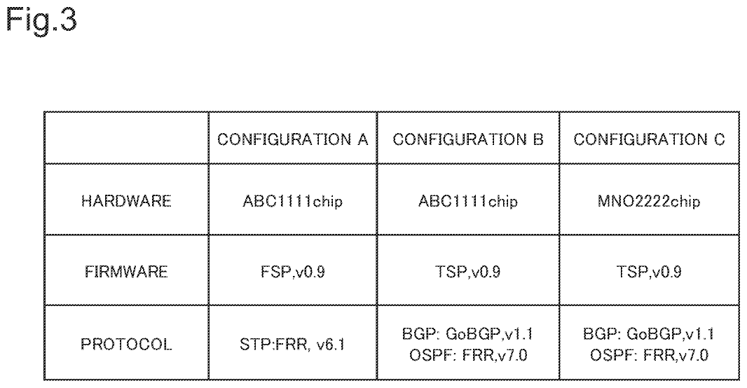

FIG. 3 is a table illustrating a storage example of the configuration information of the device according to the present embodiment. As illustrated in FIG. 3, for example, in Configuration A, a model number “ABC1111chip” of a chip name is stored as the hardware configuration information. As the firmware configuration information, a firmware name FSP (Intel Firmware Support Package) and its version “v0.9” are stored. As the protocol configuration information, “STP” that is a protocol name and information regarding protocol processing software “FRR” and version “v6.1” are stored.

For example, the target information acquisition unit 101 acquires the configuration information of the verification target device by using an operation for verification by a user as a trigger. The target information acquisition unit 101 may search for such information stored in the storage device 505. The storage device 505 stores, for example, the identifier information of the verification target and the configuration information of the verification target device in association. In this case, the target information acquisition unit 101 can acquire the configuration information associated with an ID stored in the storage device 505 by accepting an input of the identifier information such as an ID assigned to the verification target by the user. The configuration information may be stored in another configuration (for example, configuration information storage means) instead of the storage device 505. The target information acquisition unit 101 outputs the acquired configuration information of the verification target to the suitability evaluation unit 103.

The model information acquisition unit 102 is means that acquires configuration information of a device in an environment in which a learned model used for verification of a verification target is generated. The learned model is, for example, a model generated by machine learning in order to output a verification result based on verification data at the time of being normal and abnormal in the same or similar configuration in the past in each business operator. The learned model includes, but is not limited to, a decision tree model, a linear regression model, a logistic regression model, and a neural network model. The model information acquisition unit 102 acquires the configuration information of the device of the learned model used to verify the verification target, for example, by accepting an input from the input device 509 by the user. When the configuration information of the device of the learned model is stored in the storage device 505, the model information acquisition unit 102 may acquire the configuration information from the storage device 505. The configuration information of the device mentioned here is configuration information that can be compared with the configuration information acquired by the target information acquisition unit 101. That is, the configuration information of the device is configuration information of the device including hardware configuration information and software configuration information formed by firmware configuration information and protocol processing software configuration information. The model information acquisition unit 102 outputs the acquired configuration information of the learned model to the suitability evaluation unit 103.

The suitability evaluation unit 103 is means that evaluates suitability of a verification target with the learned model based on the acquired configuration information of the device of the verification target and the learned model. When the configuration information is input from the target information acquisition unit 101 and the model information acquisition unit 102, the suitability evaluation unit 103 evaluates the suitability of the verification target and the learned model. Specifically, the suitability evaluation unit 103 evaluates whether the verification target is suitable for the learned model based on similarity of the configuration information by comparing the pieces of configuration information with each other.

For example, when the similarity of the configuration information falls within a predetermined range, the suitability evaluation unit 103 evaluates that there is suitability. Conversely, when the similarity of the configuration information does not fall within a predetermined range, the suitability evaluation unit 103 evaluates that there is no suitability.

The predetermined range in the hardware configuration information is, for example, a case in which chip names are compared as the hardware configuration information and both the chip names are the same series of the same manufacturer. In this case, the suitability evaluation unit 103 determines the similarity in consideration of original equipment manufacturing (OEM) supply information with regard to the hardware configuration information. Specifically, if the manufacturer and the product information match due to OEM supply, the suitability evaluation unit 103 determines that the chip name and the manufacturer name are the same even if the chip name and the manufacturer name are different. The predetermined range in the software information is, for example, a case in which the firmware name and the protocol name match, and a difference in the version of the software is only a minor version. However, the present disclosure is not limited to this range as long as the operation of the software can be regarded as being substantially equivalent. The suitability evaluation unit 103 also determines the similarity in consideration of software-compatible information with the software configuration information. For example, considering that “FRR 2.0” and “Quagga 1.1” are compatible with each other, the suitability evaluation unit 103 determines the similarity by regarding such software information as being the same. In this way, the suitability evaluation unit 103 determines the similarity and outputs the similarity to the output unit 104.

The output unit 104 is means that outputs a result evaluated by the suitability evaluation unit 103. The output unit 104 outputs a suitability evaluation result to the output device 510 and the like. The evaluation of suitability is an evaluation of whether the learned model to be applied is suitable under the own configuration environment.

An operation of the model analysis device 100 that have the foregoing configuration will be described with reference to the flowchart of FIG. 4.

FIG. 4 is a flowchart illustrating an overview of the operation of the model analysis device 100 according to the first embodiment. The process according to this flowchart may be executed based on program control by the processor described above.

As illustrated in FIG. 4, the target information acquisition unit 101 first acquires configuration information of a device in a verification target (step S101). Subsequently, the model information acquisition unit 102 acquires the configuration information of the device in the environment in which the learned model used for verification of the verification target is generated (step S102). Subsequently, the suitability evaluation unit 103 evaluates the suitability of the verification target with the learned model based on the acquired configuration information of the device of the verification target and the learned model (step S103). Finally, the output unit 104 outputs the suitability result evaluated by the suitability evaluation unit 103 (step S104). As described above, the model analysis device 100 ends the operation of the model analysis.

In the model analysis device 100 according to the first embodiment, the suitability evaluation unit 103 evaluates the suitability of the verification target with the learned model based on the configuration information of the device including the acquired hardware configuration information of the verification target and the learned model and the software configuration information formed by the firmware configuration information and the protocol processing software configuration information. Accordingly, even in an operating environment including a plurality of pieces of software, it does not take time to search for a model that can be adapted.

### Modified Example of First Embodiment

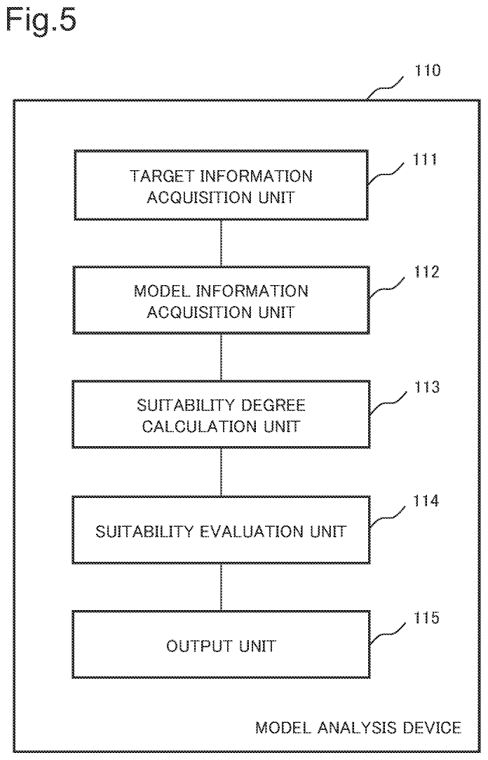

Next, a modified example of the first embodiment of the present disclosure will be described in detail with reference to the drawings. FIG. 5 is a block diagram illustrating a configuration of a model analysis device 110 according to a modified example of the first embodiment. The model analysis device 110 according to a modified example of the first embodiment includes a target information acquisition unit 111, a model information acquisition unit 112, a suitability degree calculation unit 113, a suitability evaluation unit 114, and an output unit 115. That is, the modified example of the first embodiment is greatly different in that the suitability degree calculation unit 113 is included in addition to the configuration of the first embodiment. The modified example of the first embodiment is also different from the first embodiment in that network configuration information is used as the configuration information in addition to the hardware configuration information and the software configuration information.

The target information acquisition unit 111 acquires network configuration information in addition to the hardware configuration information and the software configuration information of the verification target. The network configuration information is information indicating a connection relationship between pieces of hardware. In the present specification, the network configuration information is expressed as “A□B□C□D”. This means that a device A is directly connected to a device B, the device B is directly connected to a device C, and the device C is directly connected to a device D. A method in which the target information acquisition unit 111 acquires the network configuration information is similar to a method in which the target information acquisition unit 101 acquires the hardware information and the software information.

In the first embodiment, the model information acquisition unit 112 acquires network configuration information in addition to the hardware configuration information and the software information in which a learned model used to verify a verification target is generated. The method in which the model information acquisition unit 112 acquires the network configuration information is similar to the method in which the model information acquisition unit 112 acquires the hardware information and the software information.

The suitability degree calculation unit 113 calculates a suitability degree indicating the degree of suitability based on the similarity between the hardware configuration, the software information, and the network configuration information of the learned model and the verification target acquired by the target information acquisition unit 111 and the model information acquisition unit 112. The suitability degree calculation unit 113 sets a coefficient indicating similarity for each configuration, sets “1.0” when the similarity is completely matched, and decreases the value of the coefficient according to the degree of a different portion.

Specifically, the suitability degree calculation unit 113 sets “1.0” for the hardware configuration if the hardware configurations are of the same model number of the same manufacturer. “0.8” is set for the hardware configuration in the case of the same series of the same manufacturer. The suitability degree calculation unit 113 sets “1.0” for the software configuration when the software configurations are the same software and the same version. Even in the case of the same software, the coefficient is changed according to a difference in the version when the version is different. For example, when the different portion is a difference a minor version name, “0.9” is set. When the different portion is a difference in a major version name, “0.5” is set.

The suitability degree calculation unit 113 also calculates a suitability degree for the network configuration information based on the similarity. The similarity of the network configuration information indicates similarity of a connection relationship of devices between the devices to be configured. For example, when an own network configuration is “A□B□C□D” and a connection configuration of a network of “A□B□C” is the same (for example, “D□A□B□C”), the suitability degree calculation unit 113 sets the coefficient to “0.8”. As another example, when the own network configuration is “A□B□C□D” and only a connection configuration of a network of “A□B” is the same (for example, “A□B□D□C”, “C□A□B□D”, “D□A□B□C”, “A□B□C□D”, or “A□B□D□C”), the coefficient is “0.5”.

As described above, the suitability degree calculation unit 113 calculates the suitability degree by calculating the coefficients for the hardware configuration, the software configuration, and the network configuration, and then calculating an average of the calculated coefficients. The suitability degree calculation unit 113 may calculate the suitability degree further using the network configuration information only when the hardware configuration and the software configuration completely match. However, the method of calculating the suitability degree by the suitability degree calculation unit 113 is not limited thereto as long as the similarity of each configuration can be calculated.

Based on the suitability degree calculated by the suitability degree calculation unit 113, the suitability evaluation unit 114 evaluates suitability with the learned model of the verification target. The suitability evaluation unit 114 determines that there is the suitability when the calculated suitability degree is equal to or greater than a threshold. Conversely, when the calculated suitability degree is less than the threshold, the suitability evaluation unit 114 determines that there is no suitability. The threshold is determined in advance and is stored in, for example, the storage device 505.

The output unit 115 outputs a result evaluated by the suitability evaluation unit 114. In the output unit 115, the evaluation of the suitability is evaluation of whether the learned model to be suitable is suitable under the own configuration environment. The output unit 115 may output a result of the suitability degree calculated by the suitability degree calculation unit 113.

In the model analysis device 110 according to the modified example of the first embodiment, the suitability evaluation unit 114 evaluates the suitability with the learned model of the verification target based on the suitability degree calculated by the suitability degree calculation unit 113. Accordingly, for example, even when the hardware configuration information is different, the suitability evaluation unit 114 determines that there is suitability if the software configuration information is the same and the suitability degree is equal to or greater than the threshold. Accordingly, as a result obtained by comprehensively determining the configuration information of the device, it is possible to evaluate whether the learned model is suitable.

### Second Embodiment

Next, a second embodiment of the present disclosure will be described in detail with reference to the drawings. Hereinafter, description of repeated content of the above description will be omitted to the extent that the description of the present embodiment is not unclear. A model analysis device 120 according to the second embodiment is a device searching for which model is suitable in the own device configuration when a learned model is shared between a plurality of business operators. As in the computer device illustrated in FIG. 2, a function of each constituent in each embodiment of the present disclosure can be achieved not only by hardware but also by a computer device or firmware which is based on program control.

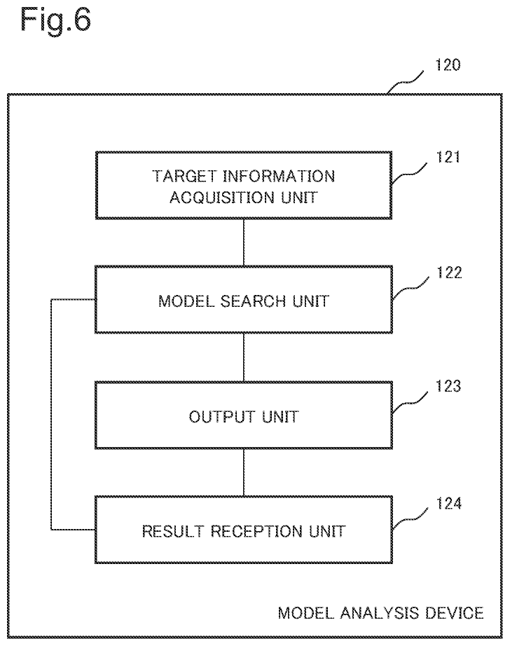

FIG. 6 is a block diagram illustrating a configuration of the model analysis device 120 according to the second embodiment of the present disclosure. Referring to FIG. 6, the model analysis device 120 according to the second embodiment will be described focusing on differences from the model analysis device 100 according to the first embodiment. The model analysis device 120 according to the second embodiment includes a target information acquisition unit 121, a model search unit 122, an output unit 123, and a result reception unit 124.

The target information acquisition unit 121 according to the present embodiment can acquire the configuration information of the verification target associated with the identifier information by inputting the identifier information such as an ID assigned to a device of the verification target. In the present embodiment, the configuration information is configuration information of a device including hardware configuration information and software configuration information formed by firmware configuration information and protocol processing software configuration information. The target information acquisition unit 121 outputs the acquired configuration information of the device to the model search unit 122.

The model search unit 122 searches for a suitable learned model based on the configuration information of the device of the verification target. When the configuration information of the verification target is input from the target information acquisition unit 121, a learned model generated in the same or similar configuration in each business operator in the past is searched for. Here, similarity refers to a case in which the similarity described in the first embodiment falls within a predetermined range. The learned model is a learned model generated by machine learning to output a verification result based on verification data at the time of being normal and abnormal in each business operator.

The output unit 123 is means that displays and outputs the learned model searched by the model search unit 122 on the output device 510 or the like. The output unit 123 may output, as metadata, a purpose of a model, a format (time, tx_pkt_cnt, or rx_pkt_cnt) of the data used in the verification data, supplementary information such as a usage method, or URL information indicating a storage location of the learned model.

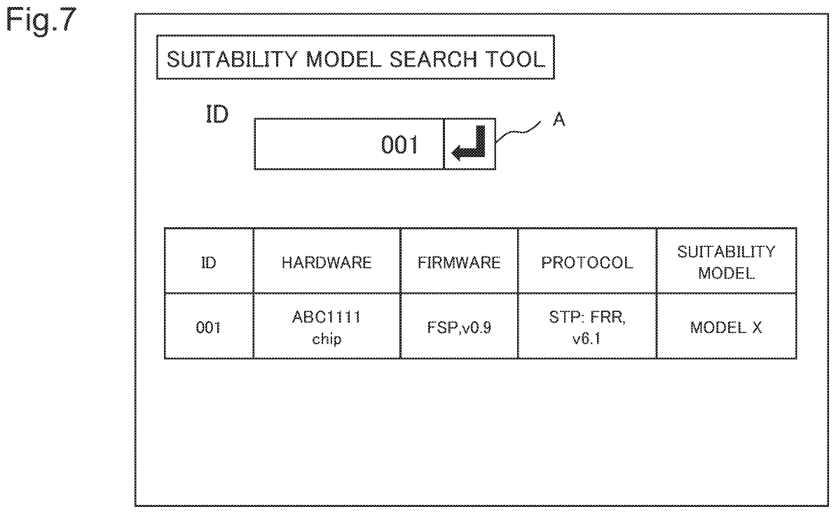

Here, in the present embodiment, a state in which the processes from acquisition of the configuration information by the target information acquisition unit 121 to output of the search result of model candidates by the output unit 123 are executed will be described. FIG. 7 illustrates an example of a display screen of a suitability model search tool. As illustrated in FIG. 7, when an ID assigned to a device of the verification target is input to the input unit A and searched for, the configuration information associated with the ID and the information of the learned model suitable for the configuration information are displayed.

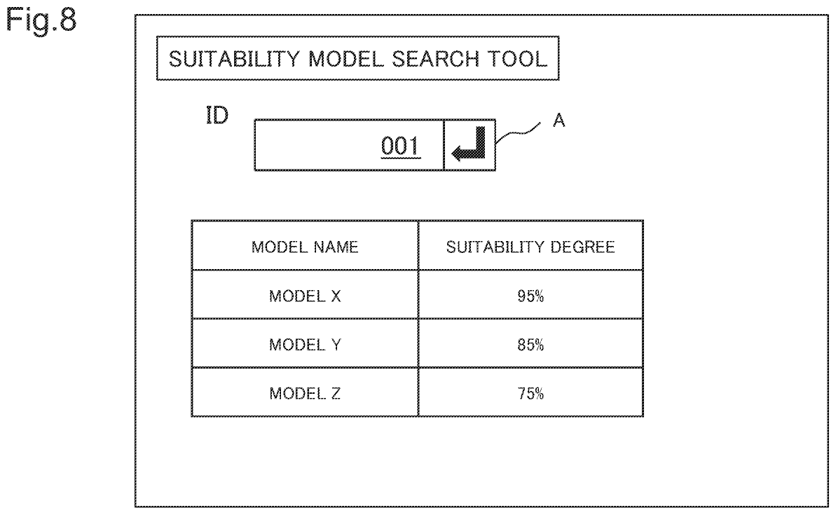

FIG. 8 illustrates another example of the display screen of the suitability model search tool. As illustrated in FIG. 8, when the ID assigned to the verification target is input to the input unit A and searched for, information regarding a learned model candidate suitable for a configuration of the verification target is displayed. The information regarding the learned model candidates in the example of FIG. 8 is output in descending order of suitability (that is, a numerical value of the suitability degree is higher) with the suitability between the model name and the verification target.

The result reception unit 124 is means that receives a suitability result of the learned model with the verification target. The result reception unit 124 receives the suitability result by an operation from the input device 509. The result reception unit 124 receives a result based on, for example, a criterion such as greater, equal, or less than the numerical value of the suitability degree output by the suitability model search tool, and stores the result in the storage device 505. When a suitable model is searched for later, the model search unit 122 searches for the suitable model with reference to the stored result.

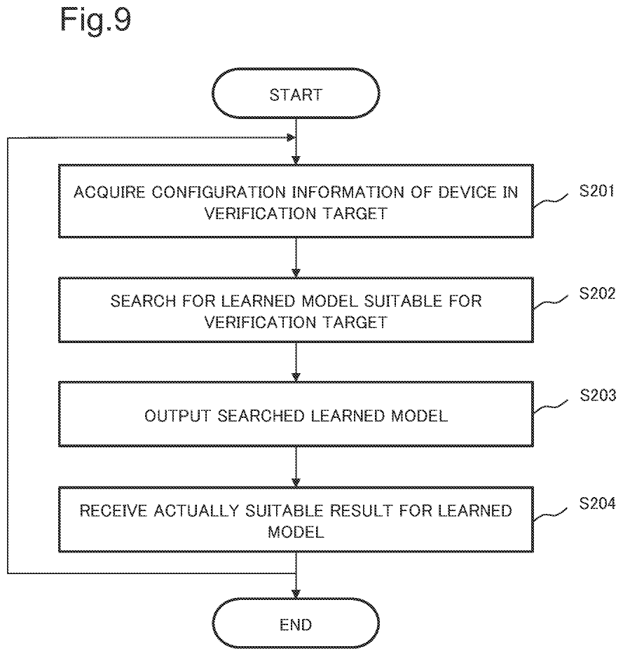

An operation of the model analysis device 120 that has the above configuration will be described with reference to the flowchart of FIG. 9.

FIG. 9 is a flowchart illustrating an overview of an operation of the model analysis device 120 according to the second embodiment. The process according to this flowchart may be executed based on program control by the processor described above.

As illustrated in FIG. 9, the target information acquisition unit 111 first acquires configuration information of a device in a verification target (step S201). Subsequently, the model search unit 122 searches for a suitable learned model based on the configuration of the device of the verification target (step S202). Subsequently, the output unit 203 outputs information regarding the learned model searched by the model search unit 122 (step S203). Finally, the result reception unit 124 receives an input of an actually suitable result for the learned model (step S204). The result received by the result reception unit 124 is used when the model search unit 122 searches for the learned model in a case in which the flow is repeated again. As described above, the model analysis device 100 ends the operation of the model analysis.

In the model analysis device 120 according to the second embodiment of the present disclosure, the model search unit 122 searches for a suitable learned model based on the configuration information of the device including hardware configuration information of a verification target, firmware configuration information, and protocol processing software configuration information. Accordingly, by inputting only the configuration information of the device, it is possible to acquire the information of the suitable learned model.

Although the present invention has been described with reference to each embodiment, the present invention is not limited to the foregoing embodiments. Various modified examples that can be understood by those skilled in the art can be made to the configuration and details of the present invention within the scope of the present invention.

For example, although the plurality of operations are described in order in the forms of the flowcharts, the order of description does not limit an execution order of the plurality of operations. Therefore, when each embodiment is achieved, the order of the plurality of operations can be changed within a range that does not interfere in content. In the present embodiment, a suitable learned model is searched for based on the configuration information of the device including the hardware configuration information of the verification target, the firmware configuration information, and the protocol processing software configuration information, but the present invention is not limited thereto. For example, the model search unit 122 may search for a suitable model based on the network configuration information and the verification content in addition to the configuration information of the device including the hardware configuration information of the verification target and the software configuration information formed by the firmware configuration information and the protocol processing software configuration information.

Some or all of the above embodiments may be described as the following supplementary notes, but are not limited to the followings.

### (Supplementary Note 1)

A model analysis device including:
target information acquisition means configured to acquire configuration information of a device including hardware configuration information in a verification target and software configuration information formed by firmware configuration information and protocol processing software configuration information;
model information acquisition means configured to acquire configuration information of the device in an environment in which a learned model used for verification of the verification target is generated;
suitability evaluation means configured to evaluate suitability of the verification target with the learned model based on the acquired configuration information of the device of the verification target and the learned model; and
output means configured to output the evaluated result.

### (Supplementary Note 2)

The model analysis device according to Supplementary Note 1, wherein
the configuration information of the device in the environment in which the verification target and the learned model are generated includes configuration information of a plurality of devices, and
the target information acquisition means and the model information acquisition means further acquire network configuration information including connection information between the plurality of devices as the configuration information.

### (Supplementary Note 3)

The model analysis device according to Supplementary Note 1 or 2, wherein hardware configuration information in the verification target and the hardware configuration information in which the learned model is generated include chip configuration information for controlling an operation of the device.

### (Supplementary Note 4)

The model analysis device according to any one of Supplementary Notes 1 to 3, further including:
suitability degree calculation means configured to calculate a suitability degree indicating the degree of suitability based on the acquired configuration information of the verification target and the learned model,
wherein the suitability evaluation means evaluates the suitability based on the calculated degree of suitability.

### (Supplementary Note 5)

The model analysis device according to Supplementary Notes 1 to 4, further including:
configuration information storage means configured to store identifier information of the verification target and the configuration information of the verification target in association,
wherein the target information acquisition means acquires the configuration information stored in the configuration information storage means based on the identifier information of the verification target.

### (Supplementary Note 6)

A model analysis device including:
target information acquisition means configured to acquire configuration information of a device including hardware configuration information in a verification target and software configuration information formed by firmware configuration information and protocol processing software configuration information;
model search means configured to search for a learned model suitable for verification of the verification target based on the acquired configuration information of the device; and
output means configured to output the searched learned model.

### (Supplementary Note 7)

The model analysis device according to Supplementary Note 6, wherein
the configuration information of the device in the verification target includes configuration information of a plurality of devices, and
the target information acquisition means further acquires network configuration information including connection information between the plurality of devices as the configuration information.

### (Supplementary Note 8)

The model analysis device according to Supplementary Note 6 or 7, wherein the hardware configuration information in the verification target includes chip configuration information for controlling an operation of the device.

### (Supplementary Note 9)

The model analysis device according to any one of Supplementary Notes 6 to 8, further including:
result reception means configured to receive a suitability result of the learned model for a verification target,
wherein the model search means searches for the compatible learned model further using the suitability result.

### (Supplementary Note 10)

The model analysis device according to Supplementary Notes 6 to 9, further including:
configuration information storage means configured to store the identifier information of the verification target and the configuration information of the verification target in association,
wherein the target information acquisition means acquires the configuration information stored in the configuration information storage means based on the identifier information of the verification target.

### (Supplementary Note 11)

The model analysis device according to Supplementary Note 6 or 7, wherein the learned model is a model that accepts the configuration information as an input and outputs the suitable learned model candidate.

### (Supplementary Note 12)

A model analysis method including:
acquiring configuration information of a device including hardware configuration information in a verification target and software configuration information formed by firmware configuration information and protocol processing software configuration information;
acquiring configuration information of the device in an environment in which a learned model suitable for verification of the verification target is generated;
evaluating suitability of the verification target with the learned model based on the acquired configuration information of the device of the verification target and the learned model; and
outputting the evaluated result.

### (Supplementary Note 13)

A model analysis method including:
acquiring configuration information of a device including hardware configuration information in a verification target and software configuration information formed by firmware configuration information and protocol processing software configuration information;
searching for a learned model suitable for verification of the device of the verification target based on the acquired configuration information of the device; and
outputting the searched learned model.

### (Supplementary Note 14)

A recording medium that stores a program causing a computer to execute:
acquiring configuration information of a device including hardware configuration information in a verification target and software configuration information formed by firmware configuration information and protocol processing software configuration information;
acquiring configuration information of the device in an environment in which a learned model suitable for verification of the verification target is generated;
evaluating suitability of the verification target with the learned model based on the acquired configuration information of the device of the verification target and the learned model; and
outputting the evaluated result.

### (Supplementary Note 15)

A recording medium that stores a program causing a computer to execute:
acquiring configuration information of a device including hardware configuration information in a verification target and software configuration information formed by firmware configuration information and protocol processing software configuration information;
searching for a learned model suitable for verification of the verification target based on the acquired configuration information of the device; and
outputting the searched learned model.

### REFERENCE SIGNS LIST

100, 110, 120 Model analysis device
101, 111, 121 Target information acquisition unit
102, 112 Model information acquisition unit
113 Suitability degree calculation unit
103, 114 Suitability evaluation unit
104, 115, 123 Output unit
122 Model search unit
124 Result reception unit

What is claimed is:

1. A model analysis device comprising:
a memory storing instructions; and
at least one processor configured to execute the instructions to:
acquire configuration information of a device including hardware configuration information in a verification target and software configuration information formed by firmware configuration information and protocol processing software configuration information;
acquire configuration information of the device in an environment in which a learned model used for verification of the verification target is generated;
evaluate suitability of the verification target with the learned model based on the acquired configuration information of the verification target and the learned model; and
output the evaluated result.

2. The model analysis device according to claim 1, wherein
the configuration information of the device in the environment in which the verification target and the learned model are generated includes configuration information of a plurality of devices, and the at least one processor is further configured to execute the instructions to:
acquire network configuration information including connection information between the plurality of devices as the configuration information.

3. The model analysis device according to claim 1, wherein hardware configuration information in the verification target and the hardware configuration information in which the learned model is generated include chip configuration information for controlling an operation of the device.

4. The model analysis device according to claim 1, wherein the at least one processor is further configured to execute the instructions to:
calculate a suitability degree indicating the degree of suitability based on the acquired configuration information of the verification target and the learned model, and
evaluate the suitability based on the calculated degree of suitability.

5. The model analysis device according to claim 1, wherein the at least one processor is further configured to execute the instructions to:
store identifier information of the verification target and the configuration information of the verification target in association, and
acquire the configuration information stored based on the identifier information of the verification target.

6. A model analysis device comprising:
a memory storing instructions; and
at least one processor configured to execute the instructions to:
acquire configuration information of a device including hardware configuration information in a verification target and software configuration information formed by firmware configuration information and protocol processing software configuration information;
search for a learned model suitable for verification of the verification target based on the acquired configuration information of the device; and
output the searched learned model.

7. The model analysis device according to claim 6, wherein
the configuration information of the device in the verification target includes configuration information of a plurality of devices, and
the at least one processor is further configured to execute the instructions to:
acquire network configuration information including connection information between the plurality of devices as the configuration information.

8. The model analysis device according to claim 6 or 7, wherein the hardware configuration information in the verification target includes chip configuration information for controlling an operation of the device.

9. The model analysis device according to claim 6, wherein the at least one processor is further configured to execute the instructions to:
receive a suitability result of the learned model for a verification target, and
search for the compatible learned model further using the suitability result.

10. The model analysis device according to claim 6, wherein the at least one processor is further configured to execute the instructions to:
store the identifier information of the verification target and the configuration information of the verification target in association, and
acquire the configuration information stored based on the identifier information of the verification target.

11. The model analysis device according to claim 6, wherein the learned model is a model that accepts the configuration information as an input and outputs the suitable learned model candidate.

12. A model analysis method comprising:
acquiring configuration information of a device including hardware configuration information in a verification target and software configuration information formed by firmware configuration information and protocol processing software configuration information;
acquiring the configuration information of the device in an environment in which a learned model suitable for verification of the verification target is generated;
evaluating suitability of the verification target with the learned model based on the acquired configuration information of the verification target and the learned model; and
outputting the evaluated result.

13. A model analysis method comprising:
acquiring configuration information of a device including hardware configuration information in a verification target and software configuration information formed by firmware configuration information and protocol processing software configuration information;
searching for a learned model suitable for verification of the verification target based on the acquired configuration information; and
outputting the searched learned model.

14. (canceled)

15. (canceled)

16. A model analysis device according to claim 1, wherein
the at least one processor is further configured to execute the instructions to:
verify a cyber security of the verification target using the learned model suitable with the verification target [0022].
